(19) United States
(12) Patent Application Publication
(10) Pub. No.: US 2005/0160112 A1
(43) Pub. Date: Jul. 21, 2005

(54) Image creating method and imaging apparatus

(76) Inventors: Jakke Makela, Turku (FI); Kai Ojala, Oulu (FI); Timo Tokkonen, Oulu (FI); Timo Kolehmainen, Oulu (FI); Markku Rytivaara, Oulu (FI)

Correspondence Address: CRAWFORD MAUNU PLLC, 1270 NORTHLAND DRIVE, SUITE 390, ST. PAUL, MN, 55120, US

(21) Appl. No.: 11/009,219

(22) Filed: Dec. 9, 2004

(30) Foreign Application Priority Data
Dec. 11, 2003 (FI) 20031816

(51) Int. Cl. G06F 17/00

(52) U.S. Cl. 707/103 R

(57) ABSTRACT

A method of creating an image file and an image capturing apparatus comprising an image sensing arrangement comprising a lens and a sensor array are provided. The image sensing arrangement is arranged to produce an image. The apparatus is configured to create an image file comprising an image and information as metadata about how to generate at least one additional image.

### FIELD

The invention relates to an image capturing apparatus and a method of creating an image file. Especially the invention relates to a digital image capturing apparatus producing image files comprising additional information as metadata.

### BACKGROUND

The popularity of photography is continuously increasing. This applies especially to digital photography, as the supply of inexpensive digital cameras has improved. Also the integrated cameras in mobile phones have contributed to the increase in the popularity of photography.

Digital photography and photo manipulation have many advantages compared to conventional film photography. Digital photos can be archived and manipulated electronically and the digital form of images offers several possibilities. One feature of digital image processing is the use of metadata. In many existing digital cameras, when an image is taken, additional information is recorded with the image. The information typically comprises for example shutter speed, aperture, focal length and date and time when the image was captured. The information may be stored in the file header of the image file in an F (Exchangeable Image File) format and the information may be accessed by suitable image processing applications.

As taking digital images is very cheap after purchasing a digital camera, it is usual that the number of images grows continuously and the archiving of images may become burdensome. This applies especially to situations where the digital camera is a low-end product or integrated into mobile equipment and capable of producing images of relatively low resolution and small size. In such cases it may be difficult to identify the relevance of for example an image taken a long time ago. Also, if the image has been taken with relatively low-quality optics, it may be necessary to correct the image later, for example for colour or exposure errors. This may be difficult without additional information about the context where the image was taken.

### BRIEF DESCRIPTION OF INVENTION

An object of the invention is to provide an improved solution for image archiving and processing.

According to an aspect of the invention, there is provided an image capturing apparatus comprising an image sensing arrangement comprising a lens and a sensor array, the image sensing arrangement being arranged to produce an image, the apparatus comprising means for creating an image file comprising an image and information as metadata about how to generate at least one additional image.

According to another aspect of the invention, there is provided a method of creating an image file comprising an image and additional metadata, the method comprising producing at least two images and including in the image file information about how to generate at least one additional image as metadata.

Preferred embodiments of the invention are described in the dependent claims.

The method and system of the invention provide several advantages. In a preferred embodiment of the invention at least one image is included in an image file as metadata. The solution provides a new way of including additional context information to images. For example, the additional image stored as metadata may be a wider-angle image that comprises information about the surroundings of the object being photographed. Thus the user may quickly determine whether for example a close-up image is taken indoors or outdoors and thus correct the possible exposure or colour errors more easily than before.

In an embodiment, the additional image may also be of different resolution than the actual image. Thus, for example, the same image may be stored in the image file with two different resolutions, i.e. with a higher resolution for larger displays and smaller resolution for small portable devices.

### LIST OF DRAWINGS

In the following, the invention will be described in greater detail with reference to the preferred embodiments and the accompanying drawings, in which

FIG. 1 illustrates an example of an imaging device of an embodiment;

FIGS. 2A and 2B illustrate an example of an image sensing arrangement;

FIG. 2C illustrates an example of colour image combining;

FIG. 2D illustrates an example of the usage of the sensor area of the imaging device;

FIGS. 3A and 3B illustrate embodiments of the invention; and

FIGS. 4A, 4B and 4C illustrate an example of an image sensing arrangement of another embodiment.

### DESCRIPTION OF EMBODIMENTS

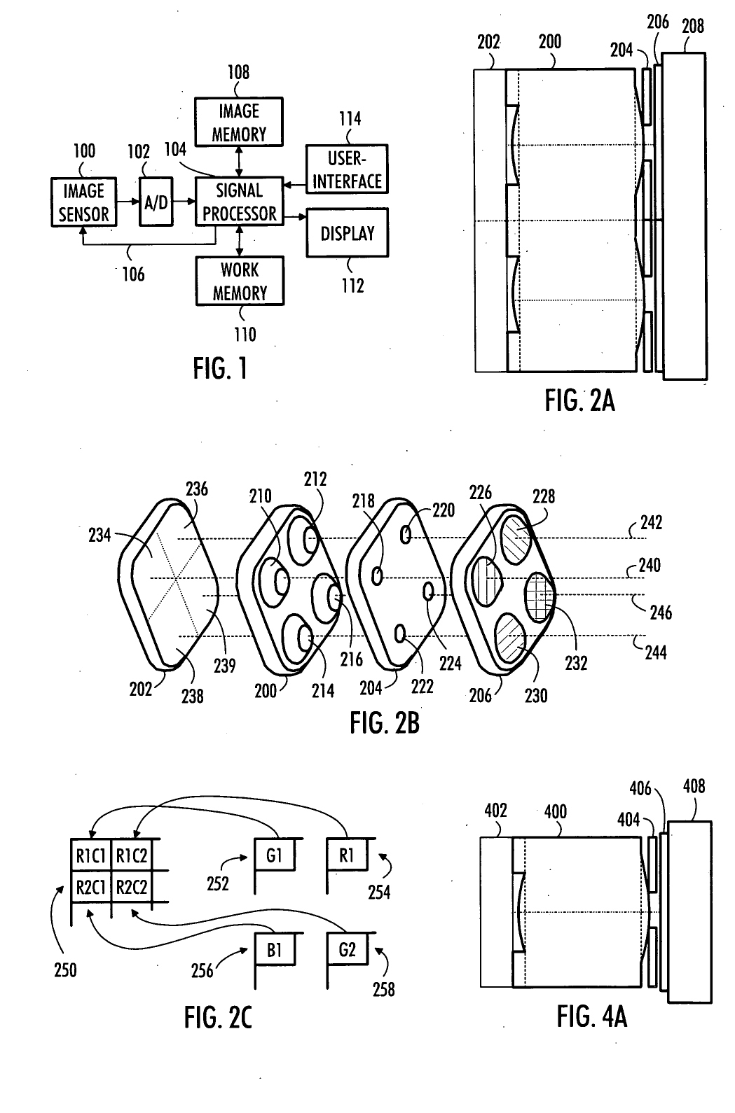

FIG. 1 illustrates a generalised digital image device which may be utilized in some embodiments of the invention. It should be noted that embodiments of the invention may also be utilised in other kinds of digital cameras than the apparatus of FIG. 1, which is just an example of a possible structure.

The apparatus of FIG. 1 comprises an image sensing arrangement 100. The image sensing arrangement comprises a lens assembly and an image sensor. The structure of the arrangement 100 will be discussed in more detail later. The image sensing arrangement captures an image and converts the captured image into an electrical form. The electric signal produced by the apparatus 100 is led to an A/D converter 102 which converts the analogue signal into a digital form. From the converter the digitised signal is taken to a signal processor 104. The image data is processed in the signal processor to create an image file. The output signal of the image sensing arrangement 100 contains raw image data which needs post processing, such as white balancing and colour processing. The signal processor is also responsible for giving exposure control commands 106 to image sensing arrangement 100.

The apparatus may further comprise an image memory 108 where the signal processor may store finished images, a work memory 110 for data and program storage, a display 112 and a user interface 114, which typically comprises a keyboard or corresponding means for the user to give input to the apparatus.

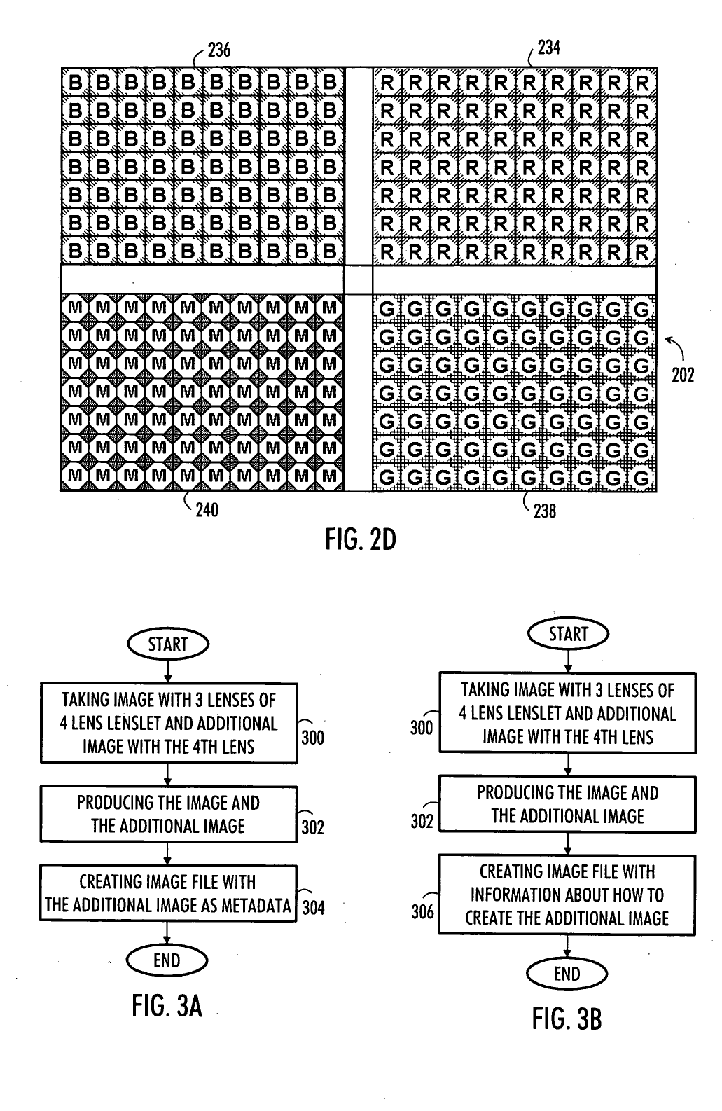

FIG. 2A illustrates an example of image sensing arrangement 100. The image sensing arrangement comprises in this example a lens assembly 200 which comprises a lenslet array with four lenses. The arrangement further comprises an image sensor 202, an aperture plate 204, a colour filter arrangement 206 and an infra-red filter 208.

FIG. 2B illustrates the structure of the image sensing arrangement from another point of view. In this example the lens assembly 200 comprises four separate lenses 210-216 in a lenslet array. Correspondingly, the aperture plate 204 comprises a fixed aperture 218-224 for each lens. The aperture plate controls the amount of light that is passed to the lens. It should be noted that the structure of the aperture plate is not relevant to the embodiments, i.e. the aperture value of each lens needs not be the same. The number of lenses is not limited to four, either.

The colour filter arrangement 206 of the image sensing arrangement comprises in this example three colour filters, i.e. red 226, green 228 and blue 230 in front of lenses 201-214, respectively. The sensor array 202 is in this example divided into four sections 234 to 239. Thus, the image sensing arrangement comprises in this example four image capturing apparatus 240-246. Thus, the image capturing apparatus 240 comprises the colour filter 226, the aperture 218, the lens 210 and the section 234 of the sensor array. Respectively, the image capturing apparatus 242 comprises the colour filter 228, the aperture 220, the lens 212 and the section 236 of the sensor array and the image capturing apparatus 244 comprises the colour filter 230, the aperture 222, the lens 214 and the section 238 of the sensor array. The fourth image capturing apparatus 246 comprises the aperture 224, the lens 216 and a section 239 of the sensor array. Thus, the fourth apparatus 246 does not in this example comprise a colour filter.

The image sensing arrangement of FIGS. 2A and 2B is thus able to form four separate images on the image sensor 202. The image sensor 202 is typically, but not necessarily, a single solid-state sensor, such as a CCD (Charged Coupled Device) or CMOS (Complementary Metal-oxide Semiconductor) sensor known to one skilled in the art. In an embodiment, the image sensor 202 may be divided between lenses, as described above. The image sensor 202 may also comprise four different sensors, one for each lens. The image sensor 202 converts light into an electric current. This electric analogue signal is converted in the image capturing apparatus into a digital form by the A/D converter 102, as illustrated in FIG. 1. The sensor 202 comprises a given number of pixels. The number of pixels in the sensor determines the resolution of the sensor. Each pixel produces an electric signal in response to light. The number of pixels in the sensor of an imaging apparatus is a design parameter. Typically in low cost imaging apparatus the number of pixels may be 640×480 along the long and short sides of the sensor. A sensor of this resolution is often called a VGA sensor. In general, the higher the number of pixels in a sensor, the more detailed image can be produced by the sensor.

The image sensor 202 is thus sensitive to light and produces an electric signal when exposed to light. However, the sensor is not able to differentiate different colours from each other. Thus, the sensor as such produces only black and white images. A number of solutions are proposed to enable a digital imaging apparatus to produce colour images. It is well known for one skilled in the art that a full colour image can be produced using only three basic colours in the image capturing phase. One generally used combination of three suitable colours is red, green and blue RGB. Another widely used combination is cyan, magenta and yellow (CMY). Also other combinations are possible. Although all colours can be synthesised using three colours, also other solutions are available, such as RGBE, where emerald is used as the fourth colour.

One solution used in single lens digital image capturing apparatus is to provide a colour filter array in front of the image sensor, the filter consisting of a three-colour pattern of RGB or CMY colours. Such a solution is often called a Bayer matrix. When using an RGB Bayer matrix filter, each pixel is typically covered by a filter of a single colour in such a way that in horizontal direction every other pixel is covered with a green filter and every other pixel is covered by a red filter on every other line and by a blue filter on every other line. A single colour filter passes through to the sensor pixel under the filter light which wavelength corresponds to the wavelength of the single colour. The signal processor interpolates the image signal received from the sensor in such a way that all pixels receive a colour value for all three colours. Thus a colour image can be produced.

In the multiple lens embodiment of FIG. 2A a different approach is used in producing a colour image. The image sensing arrangement comprises a colour filter arrangement 206 in front of the lens assembly 200. In practise the filter arrangement may be located also in a different part of the arrangement, for example between the lenses and the sensor. In an embodiment the colour filter arrangement 206 comprises three filters, one of each of the three RGB colours, each filter being in front of a lens. Alternatively also CMY colours or other colour spaces may be used as well. In the example of FIG. 2B the lens 210 is associated with a red filter, the lens 212 with a green filter and the lens 214 with a blue filter. Thus one lens 216 has no colour filter. As illustrated in FIG. 2A, the lens assembly may in an embodiment comprise an infra-red filter 208 associated with the lenses. The infra-red filter does not necessarily cover all lenses at it may also be situated elsewhere, for example between the lenses and the sensor.

Each lens of the lens assembly 200 thus produces a separate image to the sensor 202. The sensor is divided between the lenses in such a way that the images produced by the lenses do not overlap. The area of the sensor divided to the lenses may be equal, or the areas may be of different sizes, depending on the embodiment. Let in this example assume that the sensor 202 is a VGA imaging sensor and that the sections 234-239 allocated for each lens are of Quarter VGA (QVGA) resolution (320×240).

As described above, the electric signal produced by the sensor 202 is digitised and taken to the signal processor 104. The signal processor processes the signals from the sensor in such a way that three separate subimages from the signals of lenses 210-214 are produced, one filtered with a single colour. The signal processor further processes the subimages and combines a VGA resolution image from the subimages. FIG. 2C illustrates one possible embodiment to combine the final image from the subimages. This example assumes that each lens of the lenslet comprises a colour filter, in such a way that there are two green filters, one blue and one red. FIG. 2C shows the top left corner of the combined image 250, and four subimages, a green one 252, a red one 254, a blue one 256 and a green one 258. Each of the subimages thus comprises a 320×240 pixel array. The top left pixels of the subimages correspond to each other and differ only in that the colour filter used in producing the pixel information is different. The subimages are first registered. Registering means that any two image points are identified as corresponding to the same physical point. The top left pixel R1C1 of the combined image is taken from the green1 image 252, the pixel R1C2 is taken from the red image 254, the pixel R2C1 is taken from the blue image 256 and the pixel R2C2 is taken from the green2 image 258. This process is repeated for all pixels in the combined image 250. After this the combined image pixels are fused together so that each pixel has all three RGB colours. The final image corresponds in total resolution with the image produced with a single lens system with a VGA sensor array and a corresponding Bayer colour matrix.

In an embodiment, when composing the final image, the signal processor 104 may take into account the parallax error arising from the distances of the lenses 210-214 from each other.

The electric signal produced by the sensor 202 is digitised and taken to the signal processor 104. The signal processor processes the signals from the sensor in such a way that three separate subimages from the signals of lenses 210-214 are produced, one being filtered with a single colour. The signal processor further processes the subimages and combines a VGA resolution image from the subimages. Each of the subimages thus comprises a 320×240 pixel array. The top left pixels of the subimages correspond to each other and differ only in that the colour filter used in producing the pixel information is different. Due to the parallax error the same pixels of the subimages do not necessarily correspond to each other. The parallax error is compensated by an algorithm. The final image formation may be described as comprising many steps: first the three subimages are registered (also called matching). Registering means that any two image points are identified as corresponding to the same physical point. Then, the subimages are interpolated and the interpolated subimages are fused to an RGB-color image. Interpolation and fusion may also be in another order. The final image corresponds in total resolution with the image produced with a single lens system with a VGA sensor array and a corresponding Bayer colour matrix.

The fourth lens 216 of the lens assembly 200 may be used to compose an additional image. The image may be a black and white image, or the colour filter arrangement 206 may comprise a separate Bayer matrix or a corresponding colour matrix filter structure 232. Thus the fourth lens can be used to produce a colour image. The lens 216 may be different compared to the other lenses 210 to 214 of the lens assembly 200. The lens may be adapted to produce a wide-angle image, or the lens may be adapted to produce a telephoto image. In an embodiment the lens does not have an associated infra-red filter and the lens is adapted to produce an infra-red image.

FIG. 2D illustrates an example of the usage of the area of the sensor 202 and the colour filter arrangement. The image sensing arrangement comprises in this example four image capturing apparatus. The sensor array is divided into four sections 234 to 239, one for each image capturing apparatus. The sensor area 234 is reserved for the image capturing apparatus producing a red subimage. The colour filter arrangement comprises a red filter matrix in front of the sensor area 234. The sensor area 236 is reserved for the image capturing apparatus producing a blue subimage. The colour filter arrangement comprises a blue filter matrix in front of the sensor area 236. The sensor area 238 is reserved for the image capturing apparatus producing a green subimage. The colour filter arrangement comprises a green filter matrix in front of the sensor area 238. The sensor area 240 is reserved for the image capturing apparatus producing an additional image to be stored as metadata. The structure of the colour filter arrangement may vary regarding the sensor area 240, depending on the desired properties of the additional image. If the additional image is a black-and-white image, then no colour filter is required. If a colour image is desired, the colour filter arrangement may comprise a separate Bayer matrix or a corresponding colour matrix filter structure in front of the sensor area 240.

The signal processor 104 of the image capturing apparatus is thus configured to store finished images as image files into the image memory 108. In an embodiment information about how to generate at least one additional image is included in an image file as metadata. The information may comprise for example the additional image as a compressed format. The format may be the same as the format of the actual image of the image file or it may be different. The additional image may also be an uncompressed image, but this may result in a large image file.

In an embodiment, the additional images may be compressed differently than the actual image of the image file. The additional images may also be of different resolution than the actual image.

In an embodiment, the same image may be stored in the image file with two different resolutions. Thus the image file may comprise a high resolution image suitable for printing or for larger displays. The image file may also comprise the same image stored with smaller resolution as metadata, and this small resolution image may be advantageously used for example in portable devices, which have a small display. Thus the portable device is capable of displaying the image without any image processing, which enables the device to display the image faster and also saves battery consumption of the device.

In an embodiment, the same image may be stored in the image file with two different resolutions such that the image with poorer resolution is the actual image and the image with the better resolution is stored as meta-data. In addition to the high resolution image, the metadata comprises information or a link to information which enables a protection scheme such that only those who have a licence or permission can open the high resolution image.

In an embodiment, the information stored as metadata does not comprise the image itself but a link to at least one additional image. The additional image itself may be obtained by following the link, which may be a link to an image file on a server in the Internet.

The flowchart of FIG. 3A illustrates an embodiment of the invention where the above described image capturing apparatus is utilised. In step 300 a user takes a picture with the image capturing apparatus. The apparatus is configured to take a picture using the three lenses 210 to 214 and the sensor 202. The image may be a colour picture. The apparatus is further configured to take an additional picture by using the fourth lens 216 and the sensor 202. In an embodiment the image may be taken simultaneously with the image taken with the three lenses.

In step 302 the image capturing apparatus produces the images taken with the three lenses and the additional image taken with the fourth lens. The producing comprises the processing of the sensor data in the signal processor 104.

In an embodiment, the fourth lens comprises a wide-angle imaging sensing arrangement and the additional image is an image comprising information about the surroundings of the area covered by the image taken with the three lenses.

In an embodiment, the fourth lens comprises a telephoto imaging sensing arrangement and the additional image is an image comprising information about a detail of the area covered by the image taken with the three lenses.

In an embodiment, the fourth lens comprises an infra-red imaging sensing arrangement. The additional image is an image comprising infra-red information about the area covered by the image taken with the three lenses.

In step 304 the image capturing apparatus creates an image file of the image taken with the three cameras. The image file also comprises the additional image taken with the fourth lens as metadata. In an embodiment the apparatus is configured to create the image file in a JPEG2000 format and the additional image is included as a comment field in the JPEG2000 coded image file.

In an embodiment, the roles of the images may be reversed. Thus the image taken with the fourth lens may be the main image of the image file and the image taken with the three cameras may be included in the image file as metadata.

The flowchart of FIG. 3B illustrates another embodiment of the invention where the above described image capturing apparatus is utilised. Steps 300 and 302 are similar to the embodiment described above. In step 306 the image capturing apparatus creates an image file of the image taken with the three cameras. In this embodiment the image file comprises as metadata also information about how to generate the additional image taken with the fourth lens.

The information may be, for example, a link to an additional image. The additional image may be in the same memory unit as the main image or it may be located in the Internet.

In an embodiment, the apparatus is configured to create the image file in a JPEG2000 format and information about how to generate the additional image. The information may be included in the UUID box of JPEG2000 coding of the image file.

The information may also be coded in such a way that only those who have a password or some other authentication may access the additional image.

In an embodiment, the image file comprises the main image and the additional image as metadata and information coded such that only users having proper authentication may view the additional image. For example, the main image may be produced with lower resolution, and the additional image comprises the same image with higher resolution. Those wishing to view the better image may purchase a licence from an authorized vendor in order to get permission to view the image.

In an embodiment, the imaging device is configured to take images also in a streaming format, such as MPEG4. The structure of the imaging device is similar to the one described above in connection with FIG. 1. The signal processor 104 processing the image data from the image sensing arrangement 100 is configured to produce an image file in a streaming format, which may be stored in the image memory 108. There are several streaming formats available, such as MPEG4.

In this embodiment, the metadata may be incorporated as objects in the MPEG4 stream. In an embodiment, the metadata is still images, which can then be used e.g. in place of ordinary thumbnails when navigating through image clips in an image gallery. In another embodiment, the metadata can be another video clip, typically having different properties compared to the actual image stream. The metadata image may have lower resolution or frame rate, for example. This metadata can be used as a thumbnail, for example. In an embodiment, it can be used to define a compressed representation of the clip, which can be stored, for example, in a memory-restricted device while storing the actual image on a server having a larger capacity. As with the still image embodiments described above, this requires that the decoder be configured to handle this type of an embedded metadata object.

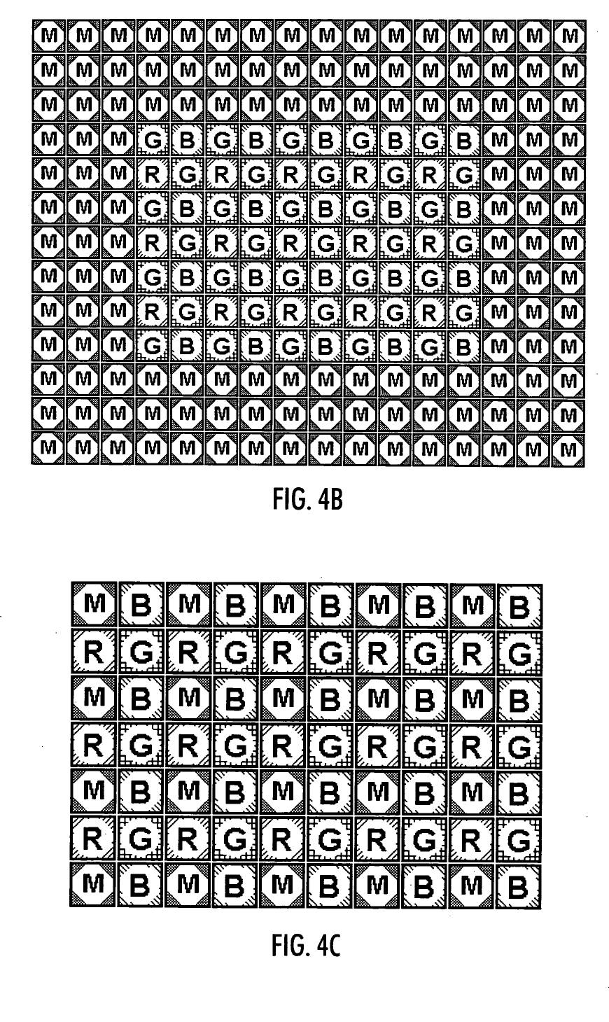

FIG. 4A illustrates another example of an image sensing arrangement 100. The image sensing arrangement comprises in this example a lens 400, an image sensor 402, an aperture plate 404, a colour filter arrangement 406 and an infra-red filter 408. FIG. 4B illustrates an example of the usage of the area of the sensor 402 and the colour filter arrangement. The image sensing arrangement comprises in this example one image capturing apparatus, instead of four, as in the embodiment of FIG. 2A. However, the sensor array is divided into two sections, as illustrated in FIG. 4B. A section of the sensor area is reserved for the actual colour image. The pixels of the section are marked with a Bayer matrix colour filter pattern of red, blue and green (‘R’, ‘B’, ‘G’). The sensor area surrounding the actual image area is reserved for the additional image stored as metadata. The area is marked with letter ‘M’ in FIG. 4B. The lens 400 is configured to cover also the metadata area. The imaging device is configured to process the data from the sensor 402 in such a way that an image file is created using the data from the central sensor area as the actual image. An additional image using the sensor data from the surrounding area is stored as metadata in the image file.

FIG. 4C illustrates another example of the usage of the area of the sensor 402 and the colour filter arrangement. In this embodiment, the pixels reserved for the metadata image (marked with ‘M’) are embedded among the pixels reserved for the main image (‘R’, ‘B’, ‘G’). The second green pixel of a typical Bayer matrix arrangement is used in this embodiment for creating an additional image.

Even though the invention is described above with reference to an example according to the accompanying drawings, it is clear that the invention is not restricted thereto but it can be modified in several ways within the scope of the appended claims.

1. An image capturing apparatus comprising:
an image sensing arrangement comprising a lens and a sensor array, the image sensing arrangement being arranged to produce an image, and
means for creating an image file comprising an image and information as metadata about how to generate at least one additional image.

2.

2. The apparatus of claim 1, further comprising means for creating an image file comprising an image and at least one additional image as metadata.

3. The apparatus of claim 1, further comprising means for compressing the additional images differently than the actual image of the image file.

4. The apparatus of claim 2, further comprising means for compressing the additional images differently than the actual image of the image file.

5. The apparatus of claim 1, further comprising at least two image sensing arrangements comprising a lens and a sensor array, the image sensing apparatus being arranged to produce at least two images.

6. The apparatus of claim 5, further comprising a sensor array which is divided between the image sensing arrangements of the apparatus.

7. The apparatus of claim 1, further comprising image sensing arrangements arranged to produce at least two images of different resolutions.

8. The apparatus of claim 1, further comprising means to create the image file in a JPEG2000 format and including information about how to generate at least one additional image as a comment field in the JPEG2000 coded image file.

9. The apparatus of claim 1, further comprising means to create images in a streaming format.

10. The apparatus of claim 9, further comprising means to create an image in a streaming format, the image comprising information as metadata about how to generate at least one additional image in a streaming format.

12. The apparatus of claim 9, further comprising means to create an image in an MPEG4 format.

13. A method of creating an image file comprising an image and additional metadata, the method comprising:
producing at least two images, and
including in the image file information about how to generate at least one additional image as metadata.

14. The method of claim 13 further comprising:
including at leas one additional image in the image file as metadata.

15. The method of claim 13, further comprising:
including in the image file a link to at least one additional image.

16. The method of claim 13 further comprising:
compressing the additional images differently than the actual image of the image file.

17. The method of claim 13, further comprising:
storing the additional images in a different format as the actual image.

18. The method of claim 13, wherein the additional images are of different resolution as the actual image of the image file.

19. The method of claim 13, wherein the metadata comprises an image taken with a wide-angle imaging sensing arrangement.

20. The method of claim 13, wherein the metadata comprises an image taken with a telephoto imaging sensing arrangement.

21. The method of claim 13, wherein the metadata comprises an image taken with an infra-red imaging sensing arrangement.

22. The method of claim 13, further comprising:
including at least one image as a comment filed JPEG2000 coding of the image.

24. The method of claim 13, further comparing:
creating images in a streaming format.

25. The method of claim 23 further comprising:
including in an image file of a streaming format at least one still image as metadata.

26. The method of claim 23, further comprising:
including in an image file of a streaming format as metadata.
